(19) United States
(12) Patent Application Publication
(10) Pub. No.: US 2025/0286075 A1
(43) Pub. Date: Sep. 11, 2025

(54) High Density Lithium-Sulfur Batteries

(71) Applicant: TDA Research, Inc., Golden, CO (US)

(72) Inventors: Vinh T. Nguyen, Arvada, CO (US); Steven Dietz, Denver, CO (US); Rhia M. Martin, Arvada, CO (US)

(21) Appl. No.: 19/076,875

(22) Filed: Mar. 11, 2025

Related U.S. Application Data
(60) Provisional application No. 63/563,629, filed on Mar. 11, 2024.

(51) Int. Cl. H01M 4/62; H01M 4/02; H01M 4/36; H01M 4/38; H01M 4/587; H01M 10/052

(52) U.S. Cl. CPC H01M 4/628; H01M 4/366; H01M 4/38; H01M 4/382; H01M 4/587; H01M 4/622; H01M 10/052; H01M 2004/021; H01M 2004/028

(57) ABSTRACT

A lithium-sulfur battery, comprising: a lithium metal anode; a sulfur cathode, comprising a carbon/sulfur composite; an electrolyte; and, a separator; wherein, the carbon/sulfur composite comprises: a carbon core; an activated carbon support comprising a plurality of pore; a sulfur species within the plurality of pores; and, a polymer membrane encapsulating the activated carbon support and the sulfur species. The plurality of pores may have a pore volume of 0.64-1.54 mL/g, and each pore may have a diameter of 2-70 nm. The polymer membrane may be lithium-conducting, comprising a surfactant that forms an isotropic cubic phase, preferably a bi-continuous cubic phase structure. The polymer membrane may have a thickness of 0.3-10 microns, and prevents polysulfide migration and stabilizes the lithium-sulfur battery. The battery has an energy density of more than 500 Wh/kg, providing a prolonged battery life for use in military equipment such as handheld radios.

### RELATED APPLICATIONS

The present application claims the benefit of priority to U.S. Patent Application No. 63/563,629, filed Mar. 11, 2024 (inventors Vinh T. Nguyen, Steven Dietz, Rhia M. Martin, internal docket no. 24-2), which is incorporated by reference herein. This present application is related to U.S. Pat. No. 8,163,204 B2, which is incorporated by reference herein. This present application is related to U.S. Pat. No. 12,122,674 B2, which is incorporated by reference herein. This present application is related to U.S. patent application Ser. No. 18/531,673 (filed Dec. 6, 2023) and Ser. No. 18/649,070 (filed Apr. 29, 2024), which are incorporated by reference herein.

### STATEMENT OF GOVERNMENT INTEREST

This invention was made in part using U.S. government funding through the United States Special Operations Command (SOCOM) contract #H92405-23-P-006. The government has certain rights in this invention.

### BACKGROUND OF THE INVENTION

High energy density batteries are in high demand to power military equipment, including handheld radio devices. Future military radio systems require additional energy storage, to give them a longer life on a single battery, provide additional power, reduce the frequency at which battery packs must be switched out, and minimize the charging time. A higher energy density battery (>500 Wh/kg) is needed for military use to guarantee an efficient and effective operation. Current lithium-ion batteries cannot be optimized to achieve a higher energy supply; rather, there is a need for new battery technologies.

Current lithium-ion batteries (LIBs) in military handheld radios have a small volume (<15 in³) and are light weight (<0.80 lbs), but they have relatively low energy density (175-256 Wh/kg). Thus, the handheld radio's batteries must be recharged frequently, which is not possible for remote missions.

Lithium-sulfur (Li—S) batteries use a sulfur cathode and a lithium metal anode. Since sulfur is not conductive, it needs a carbon support. Carbon black is often used to carry sulfur due to its low cost and high conductivity. However, carbon black has a low pore volume (0.16-0.32 mL/g), so it can't store enough sulfur to give high energy density. It lacks structural integrity as a cathode. A high amount of sulfur can be forced into the carbon matrix, but most of the sulfur will remain on the carbon surface, where it can easily migrate/escape from the cathode. Much of this loss occurs during the first discharge of the Li—S battery when the elemental sulfur is converted into intermediate lithium polysulfides (Li₂Sₙ, n=2, 4, 6, 8) and becomes more soluble in the electrolyte (especially Li₂S₆ and Li₂S₈). Thus, the capacity fades quickly, and the energy density drops greatly in the first 20 cycles.

Other commercial LIBs need either nickel or cobalt to increase their capacity. For example, lithium cobalt oxide (LCO) can have 206 Wh/kg. Lithium nickel cobalt aluminum (NCA) can be 217 Wh/kg. Adding nickel in LMO forming lithium manganese nickel oxide (LMNO) increases its capacity to 229 Wh/kg. Currently, the highest LIB capacity in the market is from lithium nickel manganese cobalt oxide (NMC). With nickel and cobalt, for example, NMC-811 with 80% nickel, 10% manganese, and 10% cobalt, the battery can reach 239 Wh/kg.

The sulfur cathode has a theoretical capacity of 1675 mAh/g. However, the sulfur and its reduced forms (lithium polysulfides) tend to leak out of the cathode as the battery is cycled. The loss of these active materials quickly decreases the battery's capacity, limiting cycle life and reducing the actual (in-use) energy density. In addition, during lithium intercalation, the volume increases and expands, leading to cracks, capacity loss, and decreased Li—S life and performance.

There is a need for a high-density handheld battery that can be used in military equipment, including handheld radios. Current LIB processes and materials are insufficient for remote missions with high usage, so there is a need for a new, higher capacity and higher density cathode material and structure.

### SUMMARY OF THE INVENTION

To overcome the limitations of the prior art, this disclosure provides a lithium sulfur battery, with a sulfur cathode comprising mesoporous activated carbon with high pore volume to store more sulfur. The sulfur is securely stored inside a stable conductive substrate, keeping the sulfur and its intermediates inside the cathode to achieve a higher energy density battery than is possible with current cathode material chemistries. The cathode contains at least 50% sulfur by weight stored in the carbon matrix, with at least 0.86 mL/g pore volume to stably contain it. Adding extra volume to give space for the lithium avoids cracks, decreases the capacity loss, and therefore increases the Li—S life and performance.

The disclosure provides a nanostructured carbon, produced by coating conventional carbon black with sugar mixtures. After carbonization, this creates an activated carbon-coated carbon black with a high surface area, a high porosity, and a high electrical conductivity. This core-shell carbon material is both highly conductive and has nanopores to hold the active material (for examples, sulfur and lithium polysulfides). The large pores enable easy access of the liquid electrolyte to the sulfur in the particles while the high surface area and high porosity ensures the desired charge transfer and storage. The carbon sulfur (C/S) composite's surface is sealed with our nanoporous Li-conducting polymer, further preventing the sulfur/lithium polysulfides leakage during cycles. The general process for forming the C/S composite material is shown in FIG. 1.

We have developed a procedure to securely store more sulfur in the pores using five different carbon supports and three protective polymers. The carbon supports and protective polymer membranes improve Li—S battery performance and stability beyond current practices. The resulting Li—S battery has higher energy density and higher capacity, allowing for longer periods of high-powered use between charges. The carbon support, with a protective layer to prevent polysulfide migration, stabilizes the Li—S batteries.

The disclosure provides a lithium-sulfur battery, comprising: a lithium metal anode; a sulfur cathode, comprising a carbon/sulfur composite; an electrolyte; and, a separator; wherein, the carbon/sulfur composite comprises: a carbon core; an activated carbon support surrounding the carbon core comprising a plurality of pores; a sulfur species within the plurality of pores; and, a polymer membrane encapsulating the activated carbon support and the sulfur species. The lithium-sulfur battery may further comprise a binder, which may be sodium carboxymethyl cellulose/styrene butadiene rubber (CMC/SBR), polyacrylic latex (LA133), or an equivalent aqueous binder.

The plurality of pores is a critical element to the cathode, and they may have a pore volume of 0.64-1.54 mL/g, or more preferably 0.86-1.54 mL/g. They may each have a diameter of 2-70 nm, or the average diameter of the system may be 2-70 nm. The pores contain the active sulfur/polysulfides, referred to as the sulfur species, which may comprise at least 50 wt % of the carbon/sulfur composite.

In an embodiment, the carbon core comprises at least one nitrogen-containing compound. The nitrogen-containing compound may be selected from the group of urea, glycine, melamine, and/or nitrogen-containing compound equivalents.

The polymer membrane is lithium conducting. In an embodiment, the polymer membrane comprises a surfactant that forms an isotropic cubic phase. In a more preferred embodiment, the surfactant forms a bi-continuous cubic phase. The surfactant may be a lyotrophic liquid crystalline (LLC) monomer. The surfactant may be a 2-tailed surfactant, and it may be a 3-tailed surfactant.

In an embodiment, the polymer membrane has a thickness of 0.3-10 microns. More preferably, the polymer membrane has a thickness of 0.4-0.6 microns. Most preferably, the polymer membrane has a thickness of 0.5 microns. The polymer membrane may prevent polysulfide migration and stabilizes the lithium-sulfur battery.

In an embodiment, the lithium-sulfur battery has an energy density more than 300 Wh/kg. More preferably, the lithium sulfur battery has an energy density more than 500 Wh/kg.

### BRIEF DESCRIPTION OF FIGURES

FIG. 1: Schematic of forming C/S composite cathode material.

FIG. 2: Energy density of C/S composites cathode coated at 0.5 microns of Li-conducting polymer film.

FIG. 3: Schematic of carbon production process.

FIG. 4: TGA analysis for different C/S composites.

FIG. 5: Discharge capacities for different C/S composites tested in coin cells.

FIG. 6: TGA analysis for SOCB7/S composites at <200 mtorr and between 150-160° C.

FIG. 7: TGA analysis for SOCB7/S composite at <200 mtorr and 120° C.

FIG. 8: XRD for SOCB7/S composite prepared at low vacuum impregnation.

FIG. 9: XRD for SOCB7/S composite prepared at high vacuum impregnation

FIG. 10: Discharge capacities of SOCB7/S composites prepared at different impregnation conditions.

FIG. 11: Discharge capacities for C/S composites formulated with CMC-SBR, LA133, and PVDF binders.

FIG. 12: Representation of a typical cubic phase.

FIG. 13: PLM images of the Gemini 6-18-EZ monomer in 15% glycerol at (a) 20° C. and (b) 55° C.

FIG. 14: Low angle XRD for Gemini/Glycerol mixture annealed at 55° C.

FIG. 15: Laser profilometer scan for a lithium conducting polymer film applied to a glass microscope slide.

FIG. 16: Discharge capacities for C/S composites with different lithium conducting polymer film thickness.

FIG. 17: Discharge capacities for C/S composites coated at 0.5 microns of Li-conducting polymer vs uncoated C/S composite.

### DETAILED DESCRIPTION OF THE INVENTION

This disclosure provides carbon supports with high pore volume to contain sulfur. Also, a proper procedure to impregnate sulfur inside the pores. Also, a nanoporous Li-conducting polymer with 3D interconnected channels (in bi-continuous cubic phase) to coat and protect the sulfur cathode. When tested in coin cells, the cathode is stable for more than 50 cycles, with a high enough capacity to construct >500 Wh/kg batteries.

In the Summary of the Invention above and the Detailed Description of the Invention, and in the claims below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

Unless defined otherwise, all technical and scientific terms used herein have the same meaning as commonly understood by one of ordinary skill in the art to which the invention belongs.

“Comprises” and grammatical equivalents thereof are used herein to mean that other components, ingredients, steps, etc. are optionally present. For example, an article ‘comprising’ (or ‘which comprises’) component A, B, and C can consist of (i.e., contain only) components A, B, and C, or can contain not only components A, B, and C but also one or more other components.

The term “at least” followed by a number is used herein to denote the start of a range beginning with that number (which may be a range having an upper limit or no upper limit, depending on the variable being defined). For example, “at least 300” means 300 or more than 300. The term “at most” followed by a number is used herein to denote the end of a range ending with that number (which may be a range having 1 or 0 as its lower limit, or a range having no lower limit, depending on the variable being defined). For example, “at most 4” means 4 or less than 4, and “at most 50%” means 50% or less than 50%. When, in this specification, a range is given as “(a first number) to (a second number)” or “(a first number)-(“a second number)”, this means a range whose lower limit is the first number and whose upper limit is the second number. For example, “1-10” means a range whose lower limit is 1 and whose upper limit is 10, where both 1 and 10 are included in that range.

The term “lithium metal anode” means any lithium metal foil or a lithium metal foil laminated onto a copper current collector, used as the negative electrode capable of providing electrons to the cathode.

The term “separator” means an electrically insulating battery separator membrane used to electronically isolate the anode from the cathode, while allowing liquid solvent and/or lithium ion to pass through during charging and discharging the battery. The separator may be a porous polymer membrane, a polypropylene membrane, a polyethylene membrane, another polymer membrane, a glass fiber membrane, a non-woven borosilicate glass fiber membrane, or an equivalent.

The term “carbon/sulfur composite” means the carbon-supported, sulfur-containing active material within the cathode. The smallest unit of the carbon/sulfur composite comprises a carbon core, carbon supports, sulfur within the pores of the carbon supports and possibly on surfaces of the carbon structure, and a surrounding lithium-activated polymer membrane. Preferably, it is formulated with an effective aqueous binder, such as CMC/SBR, LA133, or equivalents.

The term “carbon core” means a carbon-based center made from a conductive carbon nanostructured material, upon which the carbon support is formed. Preferably, the carbon core comprises carbon black, or an equivalent conductive carbon material, which provides a conductive base for the carbon supports. It may optionally comprise nitrogen-containing compounds for increased binding of sulfur to the carbon surface. These nitrogen-doped carbon compounds may include urea, glycine, melamine, and equivalents.

The term “activated carbon support” means a core-shell, mesoporous structure containing pores which can contain sulfur. The activated carbon support is produced by carbonization of sugar mixtures on the carbon core, leading to a highly porous structure with high surface area so activated material (i.e., sulfur, lithium polysulfides) may enter and be held in the pores.

The term “pores” means small, interconnected channels located throughout the carbon support, and extending to the outside of the carbon support, allowing for sulfur/sulfur polysulfides to enter the channel system through vacuum or other sulfur impregnation method. Pore diameters may range from 2-70 nm. Pore volumes may range from 0.6-1.6 mL/g.

The term “sulfur species” means active sulfur material, comprising elemental sulfur which may be mixed with elemental carbon, preferably at a 70/30 weight ratio, but possibly at any ratio with a majority sulfur (60/40, 65/35, 70/30, 75/25, 80/20, 85/15).

Sulfur may comprise at least 50 wt % of the carbon/sulfur composite, which refers to the weight of elemental sulfur within the fully formed composite prior to any charge/discharge cycles. Sulfur may also comprise at least 30 wt %, at least 40 wt %, at least 42 wt %, at least 45 wt %, at least 50 wt %, at least 55 wt %, at least 60 wt % of the carbon/sulfur composite.

The term “polymer membrane” means a protective film, comprised of lithium conductive polymer-based material containing highly-uniform nanometer-diameter pores which may be filled with liquid electrolyte. The polymer membrane material must be able to form an isotropic cubic phase, most preferably a bi-continuous cubic phase structure. The polymer may derive from a two-tailed or three-tailed surfactant.

The term “encapsulating” means surrounding the cathode material so the active material (i.e., sulfur) is sealed within the pores of the carbon support, without being too thick or dense that lithium ions cannot quickly enter and exit the cathode.

In the claims, the carbon support comprises a plurality of pores, which may be at least 1, at least 2, at least 3, at least 4, at least 5, at least 6, at least 7, at least 8, at least 9, at least 10, at least 15, at least 20, at least 30 pores or more.

The plurality of pores has a pore volume of 0.64-1.54 mL/g, or also 0.60-1.60 mL/g, 0.7-1.54 m L/g, 0.8-1.54 m L/g, 0.86-1.54 m L/g, 0.9-1.54 m L/g, 1.0-1.54 m L/g, 1.14-1.54 m L/g, 1.32-1.54 m L/g.

The pores in the plurality of pores have a pore diameter, which may be different for each individual pore, where the average pore diameter or at least one pore diameter may be 2-70 nm, 4-70 nm, 2-18 nm, 2-20 nm, 2-50 nm, 4-50 nm, 10-70 nm, 25-70 nm, 15-50 nm, 20-70 nm, 2-10 nm, 22-70 nm, 2-4 nm, 4-10 nm, 4-18 nm, 4-20 nm.

The protective polymer membrane layer may have a thickness of 0.3-10 microns. It may be 0.3, 0.5, 1, 5. 10, 0.4, 0.6, 2, 3, 4, 6, 7, 8, 9, 0.3-8, 0.3-1, 0.4-0.6, 0.5-1, 0.3-5, 0.3-2, 0.45-0.55, 0.3-0.7, 0.4-1, 0.5-2, 0.5-5, 1-5, 0.5-1.5 microns thick.

The lithium-sulfur battery comprising the cathode materials described herein has an advantageous energy density to other available lithium-ion and lithium-sulfur batteries. The energy density may be more than 300 Wh/kg, more than 350 Wh/kg, more than 375 Wh/kg, more than 400 Wh/kg, more than 425 Wh/kg, more than 450 Wh/kg, more than 475 Wh/kg, more than 500 Wh/kg, more than 510 Wh/kg, more than 515 Wh/kg, more than 525 Wh/kg, more than 550 Wh/kg, more than 570 Wh/kg.

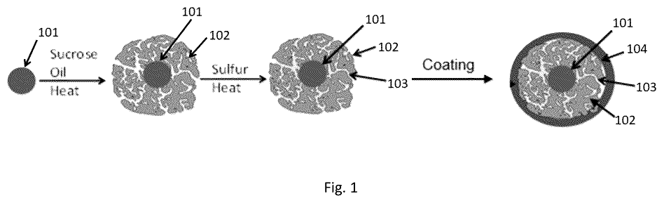

The carbon supports have a core-shell structure and high pore volume. The core is formulated with carbon black to provide good conductivity. To create the shell, the carbon black core is coated with carbohydrates. After carbonizing and activating, the shell forms a mesoporous layer with a large pore volume. Thus, the carbons have both high electrical conductivity and a high capacity to hold onto sulfur. Depending on the ratio of carbon and carbohydrate, pore length and width can be varied. A representation of the C/S composite cathode material is shown in FIG. 1, comprising first the carbon black (101), then the activated carbon (102), which forms pores for containing sulfur (103), and finally a nanoporous Li-conducting layer (104).

The pore volume may range from 0.64 to 1.54 mL/g, which is much higher (2 to 10 times) than the pore volumes of carbon black. The carbon supports may also have pore sizes ranging from 2-70 nm, facilitating sulfur impregnation and effectively keeping the active material inside the pores. Using the disclosed impregnation procedure, ˜50 wt % sulfur is successfully loaded inside the pores of the carbon support (SOCB7, pore volume=1.56 mL/g). This amount of sulfur occupies approximately 55% of SOCB7's total pore volume. The remaining 45% of the volume is left empty to accommodate the volume expansion during lithium intercalation. Coin cell cycling indicates >1400 mAh/g, corresponding to >3010 Wh/kg energy density of the sulfur cathode.

The carbon/sulfur composite is formulated with an effective binder, and then a protective lithium conductive layer is applied to seal in the sulfur contained in the pores. The nanopores are large enough (and have the right chemistry) to let the lithium ions quickly enter and leave the cathode, but still trap the larger polysulfides in the pores. CMC/SBR is most compatible and suitable for binding C/S composites due to its excellent adhesion, flexibility, and dispersion. A robust cathode layer with high reversible capacity is formed using this binder, especially on the first cycle (<10% loss). Next, the electrode is coated with a lithium conductive polymer.

A signature feature of the polymer is its highly uniform, nanometer-diameter pores, with pore surfaces entirely composed of covalently bound charged functional groups. These nanopores can be filled with a liquid electrolyte, which is highly ionic conductive, but the nanopores are still small enough to prevent unwanted molecules from passing through.

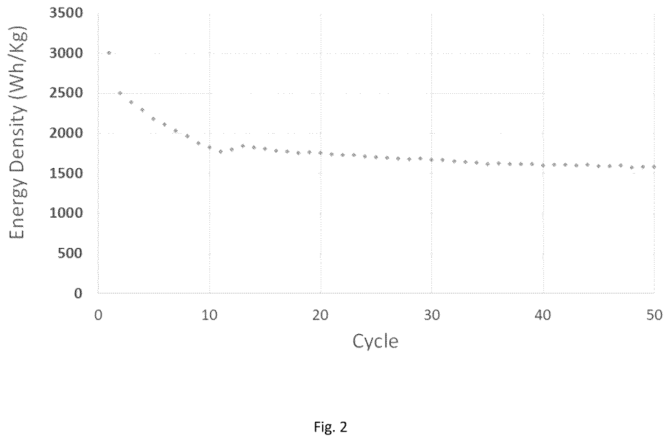

The polymer is made from lyotrophic liquid crystalline (LLC) monomers. After self-assembly and polymerization, this material forms a highly stable and Li⁺ conductive polymer material. The choice of the crystal structure adjusts the conductivity. Several different structures can be made, and the one that forms is determined by how much polar solvent is added prior to self-assembly. In a preferred embodiment, the structure is the pure bi-continuous cubic phase. Three examples of LLC monomers are named Gemini 6-18-EZ-C2, Gemini-Ether, and 3-tailed surfactant. These surfactants form a bi-continuous cubic phase with glycerol at 55° C. An ExactaCoat OP3 Ultrasonic Sprayer to precisely applied a 0.5-micron layer on top of the sulfur cathode. Then the layer was heated and UV-cured to lock the phase. The resulting cathode was tested in coin cells, showing a highly stable charge/discharge cycle for over 50 cycles. After 50 cycles, the coin cell capacity is stable at around 800 mAh/g, corresponding to 1720 Wh/kg as shown in FIG. 2. This shows that the cathode materials correspond with making 576 Wh/kg batteries.

To prepare the carbon/sulfur composite, carbon black is mixed in carbohydrates (which may be sucrose, glucose, fructose, or cornstarch) and then the ingredients are heated to form a char. After carbonizing and activating the char, a core-shell carbon is produced. The presence of the carbon black also increases the electrical conductivity of the final carbon supports. To bind and anchor sulfur on the carbon surface, nitrogen-doped carbon may be used. To dope nitrogen, urea, glycine, or melamine may be added to the formulation.

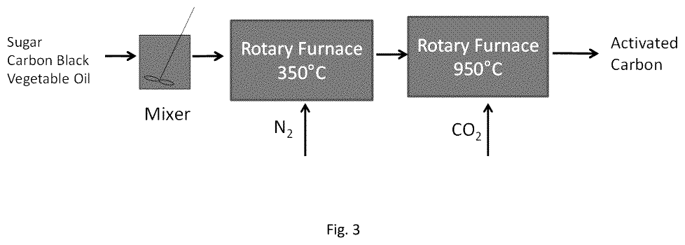

The type and quantity of the nitrogen compounds controls the concentration and functionality of the nitrogen groups dispersed in the carbon surface. In addition, adjusting the formulations and process conditions influences the surface area, pore size distribution, and shell thickness (i.e., the depth). A flow diagram of the procedure for preparing the core-shell carbons is shown in FIG. 3, with the steps as follows: 1) mix ingredients (carbon black, carbohydrate, vegetable oil, and, optionally, nitrogen-containing compounds); 2) heat (200° C.) in the air to make a char; 3) carbonize in a furnace under a flow of nitrogen (375° C.); 4) activate with carbon dioxide at 950° C. to increase the surface area (500-1400 m²/g).

Since the carbon powder shows good mechanical stability, both the carbonization and activation steps may be done in the continuous rotary furnace. In the first pass through the rotary furnace, the char was carbonized under flowing nitrogen at 350° C. In the second pass through the rotary furnace, the carbon was activated under a flow of carbon dioxide at 950° C. until the desired surface area was reached. Three different varieties of our carbon core-shell are shown, made by this method (SOCB7, AMSN330, and AMS200).

To study the effect of pore size distribution on the capacities and durability of the Li—S battery, two carbon supports (RF60 and RF78) were made with larger pores and narrower size distributions. These carbons were derived from resorcinol/formaldehyde (RF) polymers. In sealed vessels, the polymers were prepared from an aqueous mixture of resorcinol and formaldehyde. Controlling the amount of water in the formulations also independently controls the distribution of mesopores (with pore diameters between 2 and 50 nm). To carbonize the RF polymers, they were heated under nitrogen to 900° C.

All the produced carbons have a different surface area, pore volume, and pore diameter. Two of these carbons also contain nitrogen atoms to increase the sulfur binding energy (AMSN330 and AMS200). Table 1 summarizes all the carbon supports used in further examples and descriptions.

TABLE 1
Surface areas and pore sizes of carbon supports

| | Surface Area | Pore Volume | Pore Diameter |
|---|---|---|---|
| Formulation | (m²/g) | (mL/g) | (nm) |
| SOCB7 | 1391 | 1.54 | 4 |
| RF60 | 903 | 1.32 | 18 |
| RF78 | 576 | 1.14 | 22 |
| AMSN330 | 577 | 0.64 | 70 |
| AMS200 | 1638 | 0.86 | 2 |

To impregnate sulfur inside the pores, sulfur and carbon were mixed at a 70/30 weight ratio, respectively, and then heated the mixture at 150-160° C. for 18 hours, using a vacuum assist to ensure pore filling with melted sulfur. After cooling, the composite was characterized with TGA. BET analysis indicates a larger pore diameter could lower the carbon support's pore volume. The optimal sulfur amount can be calculated based on the Barrett-Joyner-Halenda equation as following:

$${S}_{opt} \% = \frac{1}{\frac{{M}_{{Li}_{2} S}}{{V}_{pore} \times {ρ}_{{Li}_{2} S} \times {M}_{s}} + 1} \times 100 \%$$

Where ρ_{Li}_{₂}_{S}=1.66 g/cm³, M_{Li}_{₂}_{S}=45.95 g/mol, and M_{S}=32.065 g/mol.

As shown in Table 2, SOCB7 is the preferred carbon to store sulfur because it has the highest pore volume with a relatively small pore diameter. As a result, SOCB7 can securely store more sulfur than the others. The theoretical capacity of Li—S is 1675 mAh/g. Thus, with the SOCB7/sulfur composite cathode, the Li—S battery can cycle at 1073 mAh/g at 2.15 V. That produces 2307 Wh/kg energy density for the cathode alone. Combining the C/S cathode with a lithium metal anode produces batteries with energy density >500 Wh/kg.

TABLE 2
Estimated energy density of the C/S composite from
the amount of sulfur in each carbon support

| | Pore | Pore | | | Energy |
|---|---|---|---|---|---|
| | Volume | Diameter | Sₒₚₜ | Capacity | Density |
| Formulation | (mL/g) | (nm) | % | (mAh/g) | (Wh/kg) |
| SOCB7 | 1.54 | 4 | 64.08 | 1073 | 2307 |
| RF37 | 0.72 | 10 | 45.48 | 762 | 1638 |
| RF60 | 1.32 | 18 | 60.46 | 1013 | 2178 |
| RF78 | 1.14 | 22 | 56.91 | 953 | 2049 |
| AMS200 | 0.86 | 2 | 49.91 | 836 | 1797 |
| AMSN330 | 0.64 | 70 | 42.57 | 713 | 1533 |

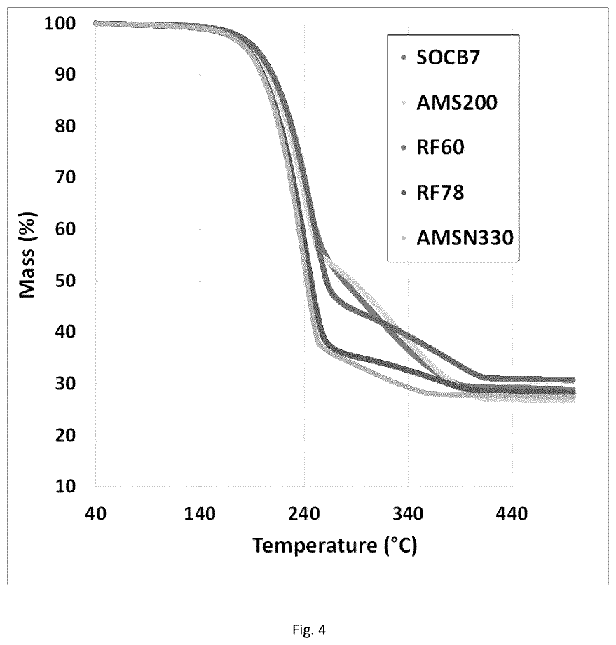

Shown in FIG. 4 is two weight loss slopes representing sulfur losses on the surface and in the pores. Sulfur located on the carbon surface started to vaporize at about 180° C. On the other hand, sulfur in pores evaporated at a higher temperature, approximately 260° C. At this point, the weight loss due to sulfur vaporization switched from external sulfur to internal sulfur. The data indicates SOCB7 has the most sulfur stored inside the pores (about 26.4%). This is still far below the highest optimal sulfur estimated from the Barrett-Joyner-Halenda equation (64.08%). Interestingly, AMS200, with a relatively lower pore volume (0.86 mL/g), stores about the same amount of sulfur stored in SOCB7. Possibly, since the AMS200 pore size is small (2 nm), it is more effective to store and protect the impregnated sulfur. However, theoretical calculations and experimental observations generally show that higher pore volumes are needed to store more sulfur effectively.

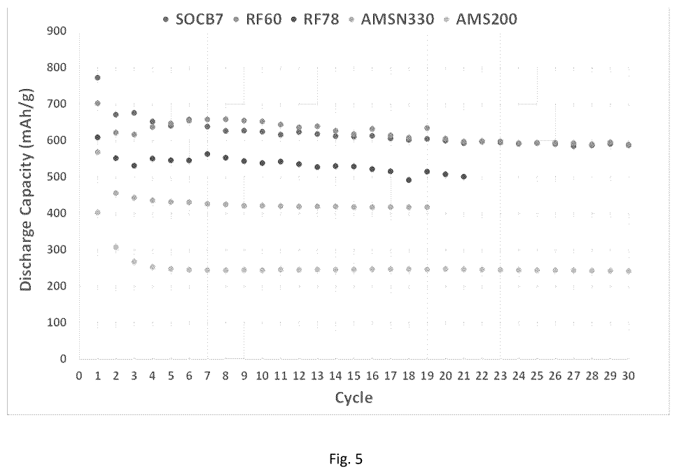

FIG. 5 shows the discharged capacities tested in coin cells for the different C/S composites. The initial discharged capacities for C/S cathodes made from SOCB7, RF60, RF78, AMSN330, and AMS200 were 772.2 mAh/g, 701.8 mAh/g, 608.1 mAh/g, 567.9 mAh/g, and 402.1 mAh/g, respectively. These capacities fall in the same trend of effective sulfur loading in the pores, except AMS200, which has the smallest pore size and could resist lithium diffusion. In conclusion, SOCB7 is the preferred candidate to store sulfur, although it only contains 26.4 wt % of sulfur inside the pores, much less than its optimal sulfur estimation (64.08%). The sulfur loading percent is improved by the sulfur impregnation method.

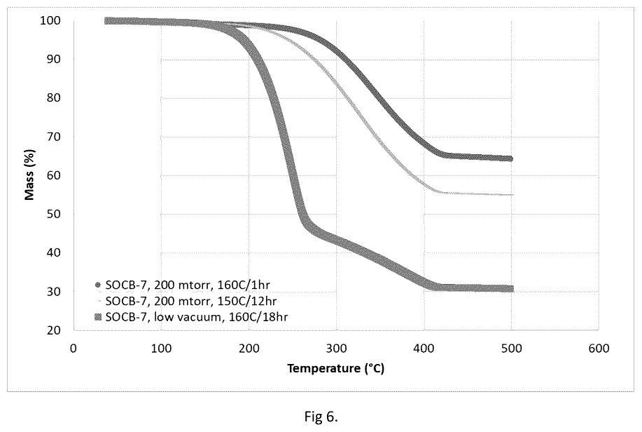

Higher pressure gradient between the carbon surface and the pore channels can draw more sulfur into the pores. At <200 mtorr, with temperature at 160° C. for 1 hour, argon was slowly bled in to force more sulfur from the surface to the pores. With this slight change, 34.8% sulfur was drawn, as shown in FIG. 6. In another sample, the temperature was held at 150° C. for 12 hours and argon was slowly bled in as described. This time, the vacuum/ambient cycle was repeated 2 more times at 1 hour each cycle. The sample now contained 44.4% of sulfur in the pores.

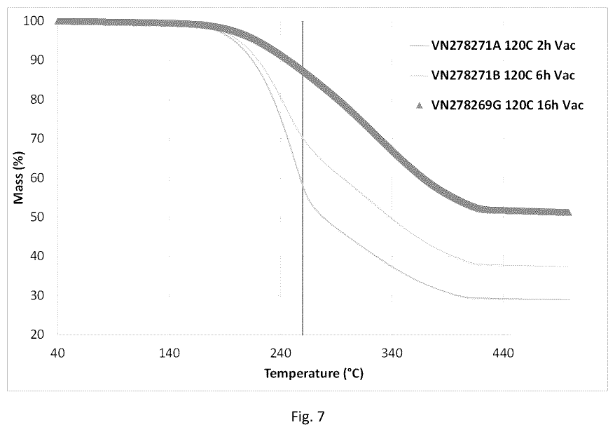

This impregnation method continues to improve the sulfur loading in the pores. For example, with the temperature at 120° C. for 2, 6, and 16 hours and then slowly bleeding in argon to force more sulfur from the surface to the pores, the amount of sulfur in the pores was 30% after 2 hours, 34% after 6 hours, and ˜50% after 16 hours. FIG. 7 shows the TGA of the samples after the impregnation. An alternate method for impregnating the carbon may occur at high temperatures in an autoclave.

To prepare the C/S composite, a one-step impregnation at 500° C. under vacuum is the preferred method. The optimal loading is about 7-8 mg/cm², (˜10 mil gap).

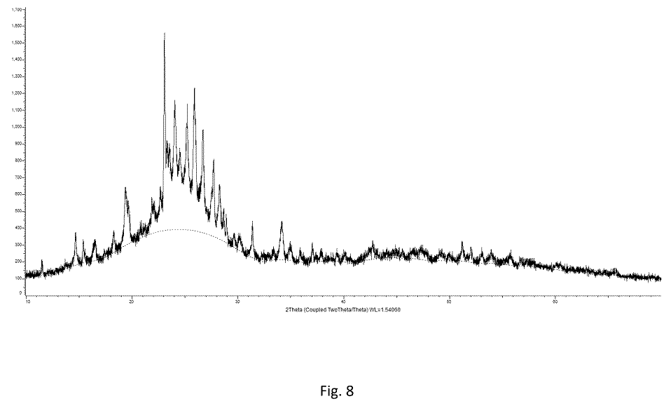

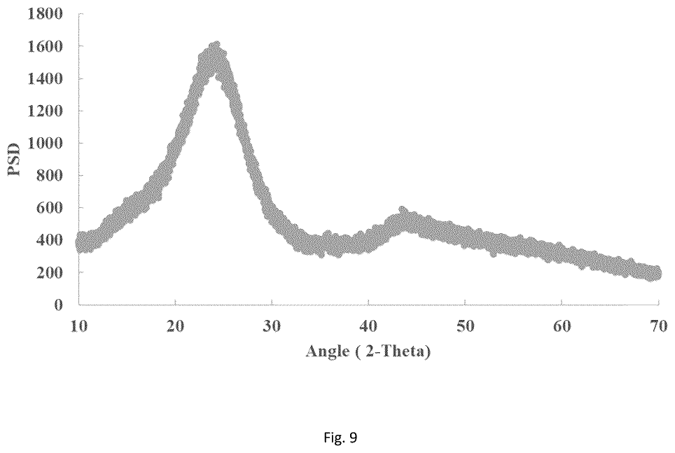

FIG. 8 and FIG. 9 show XRD taken from samples prepared at low and high vacuum, respectively. FIG. 8 shows many sharp peaks around the amorphous carbon diffraction (25°), which comes from the crystalline sulfur on the carbon surface. FIG. 9 shows the XRD of the SOCB7/S composite prepared at high vacuum impregnation. This time, the XRD pattern shows two broad featureless diffraction peaks at about 25° and 43°, which come from the carbon. This means ˜50 wt. % of sulfur detected from TGA is located inside the carbon pores and, therefore, could not be detected by XRD.

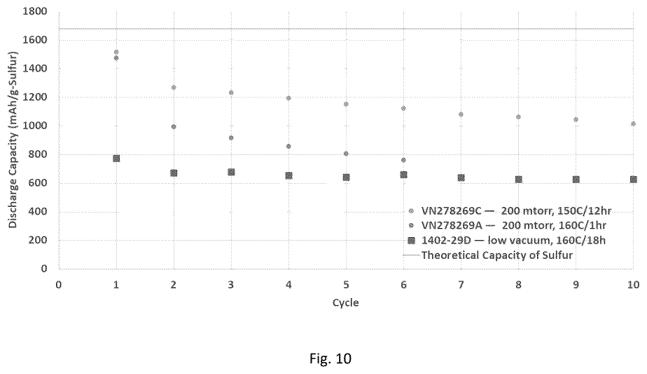

The three SOCB7/S composites were cast on aluminum sheets, dried, and tested in coin cells using lithium metal anode and 1 M LiTFSI in DOL:DME (1:1 wt.) electrolyte. FIG. 10 shows that discharged capacities started at ˜1512.7 mAh/g for the sample with ˜50 wt. % sulfur. After 10 cycles, its discharged capacity stabilized at ˜965.9 mAh/g. Accounting for all inert materials on this cathode, the cathodic energy density could be nearly 857.7 Wh/kg.

The binder is an essential component of the electrode. During the slurry coating process, the cathode needs a binder to form a uniform coating on the current collector, free of defects. After drying, the binder strongly bonds the active materials and conductive additives on the current collector and keeps the electrode films integrated. As a result, the electrode has sufficient electrical contact and structural robustness for assembling and testing. Binder functional groups interact with active materials and disperse them uniformly.

Conventional battery electrodes use a PVDF binder, but PVDF is ineffective for sulfur cathodes because its structure has low binding energy to sulfur or polysulfides. To further prevent polysulfides dissolution, alternative binders are used. Binders with chemical structures containing heteroatoms (such as oxygen and nitrogen atoms) can effectively bind and hold the polysulfides in the cathode. For example, sodium carboxymethyl cellulose and styrene-butadiene rubber (CMC/SBR) or polyacrylic latex (LA133) binders. CMC/SBR and LA133 are both excellent water-soluble binders that can facilitate the dispersion of sulfur/polysulfides active materials, maintaining a uniform and electrochemically favorable structure in the sulfur electrode and leading to better cycling performance than PVDF binder. These binders also have extra flexibility to handle the volume expansion that the sulfur cathode experiences during the lithiation process (discharge). Water-based binders also allow the case electrode to easily dry at room temperature.

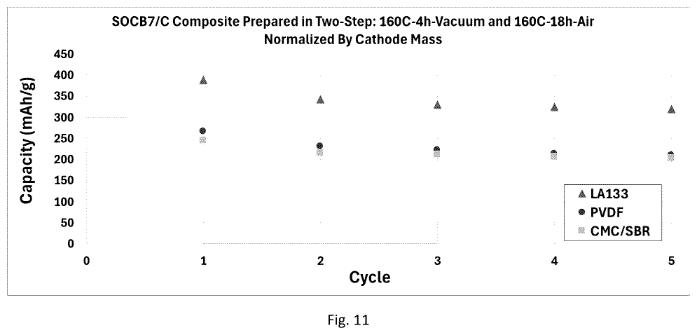

FIG. 11 shows the discharged capacities of coin cells constructed of different binders. The coin cells were prepared in two steps at 160° C. (in vacuum first for 4 hours and then in air for 18 hours). As shown, the cathode with LA133 has an exceptionally high capacity compared to the others. The initial capacity is almost 390 mAh/g normalized to the total cathode weight. LA133 is the preferred and most effective binder, though additional routine experimentation may reveal alternative effective binders.

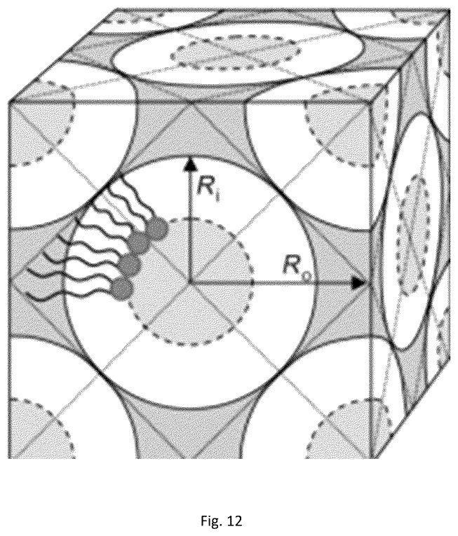

The Li-conducting polymer is a polymer-based material containing highly uniform, nanometer-diameter pores, with pore surfaces entirely composed of covalently bound charged functional groups as illustrated in FIG. 12. These nanopores can be filled with a liquid electrolyte. The polymer is made from lyotrophic liquid crystalline (LLC) monomers. After self-assembly and polymerization, this material forms a highly stable and Li⁺ conductive polymer material. The choice of the crystal structure adjusts the conductivity. Several different structures can be made, and the one that forms is determined by how much polar solvent is added prior to self-assembly. The preferred structure with the highest conductivity is the pure bi-continuous cubic phase.

A first example of the lithium conducting polymer uses the Gemini 6-18-EZ-C2 surfactant. This compound is a double-headed, C2-substituted imidazolium structural motif with a C6-alkyl linker between them and polymerizable diene tails. The structure of Gemini 6-18-EZ-C2 is shown below:

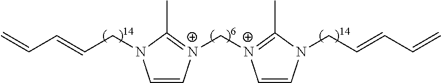

The resulting nanoporous material made from this “Gemini” contains nanochannels with high lithium conductivity to make an artificial SEI layer of lithium-ion batteries. This material can be used to coat the C/S cathode to prevent loss of sulfur and polysulfides during cycling.

A second example uses the Gemini-Ether surfactant with a more hydrophilic head group. The linker was modified from C6-alkyl to a diethyl-ether, as shown below:

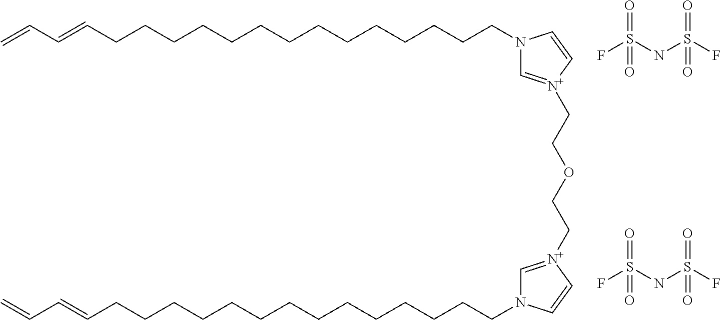 [SMILES: C=C/C=C/CCCCCCCCCCCCCCn1cc[n+](CCOCC[n+]2ccn(CCCCCCCCCCCCCC/C=C/C=C)c2)c1 ; O=S(=O)(F)NS(=O)(=O)F ; O=S(=O)(F)NS(=O)(=O)F]

Like Gemini 6-18EZ-C2, this liquid crystal surfactant was synthesized in the bromide form and can be ion exchanged for other anions, like TfSI⁻. When coated, these monomers are arranged as small channels to prevent the large polysulfides from escaping the cathode. In addition, they also can decrease the charge transfer resistance of the cathode and facilitate easier lithium intercalation during charge/discharge cycling.

In another example, the surfactant's geometry was varied with three tails (instead of two in Gemini). The 3-tailed surfactant has a negatively charged head group, potentially increasing the mobility of positively charged lithium ions through the protective layer. Furthermore, it is synthesized in a lithium-rich environment, eliminating the need to ion exchange the head groups after polymerization. The overall synthesis route of this monomer is described in Scheme 1.

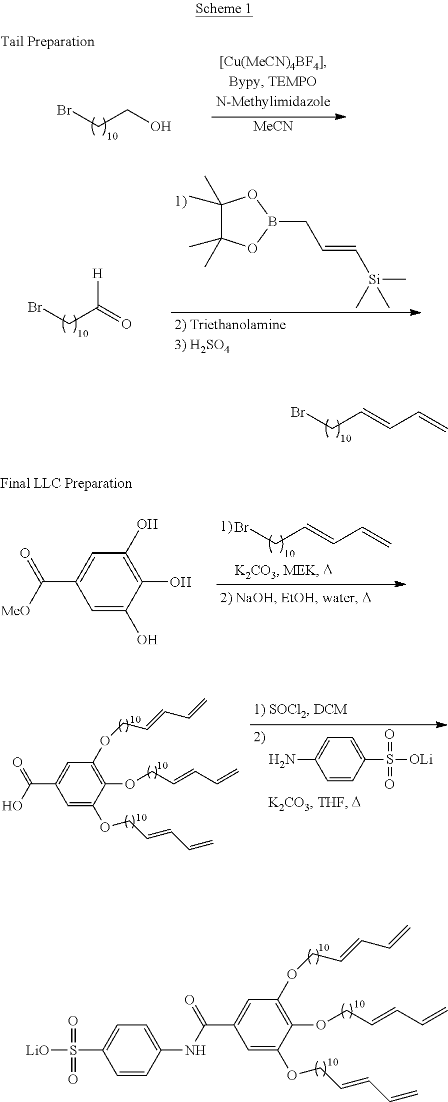

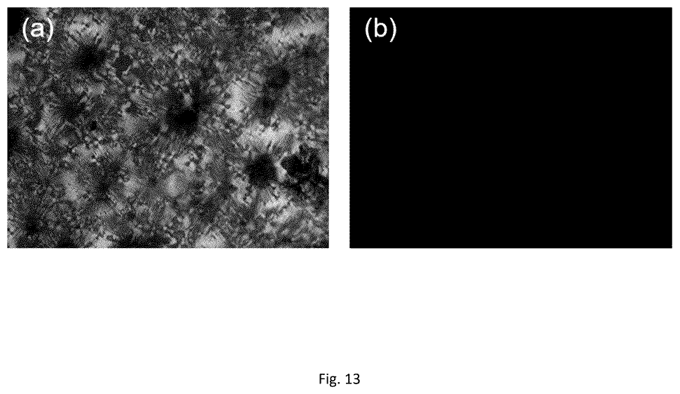

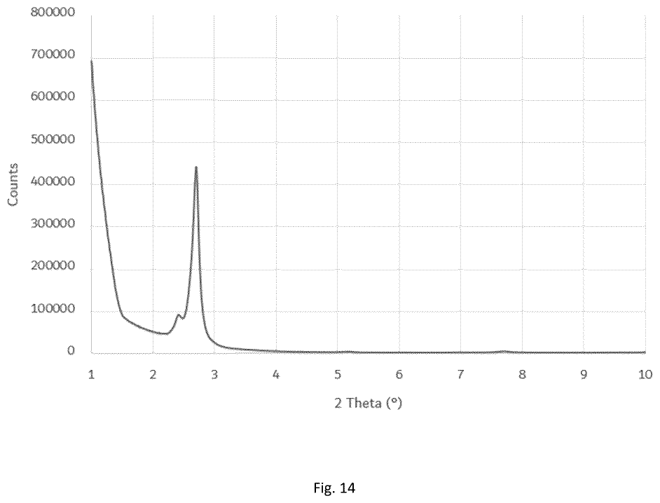

An important aspect of these surfactants, and other possible surfactants, is whether they can form an isotropic cubic phase. The necessary cubic phase is verified using polarized light microscopy (PLM). In this technique, the surfactant monomer is combined with varying concentrations of solvent (glycerol, water, propylene carbonate, etc.), coated onto a microscope slide, and observed under a microscope with polarized light. The anisotropic phases (noncubic—hexagonal or lamellar) appear as bright-colored crystals, while the isotropic phases (cubic) appear black. The microscope slide is also on a temperature stage that allows the experimenter to increase the temperature slowly and identify at what temperature it is possible to form the cubic phase with the concentration of solvent used. As the sample is heated, the colored crystals will lose intensity and eventually turn black, indicating a cubic phase is achieved at that temperature. Using PLM, the ability of the monomers to form a cubic phase with glycerol at certain temperatures is verified. For example, the Gemini 6-18-EZ-C2 monomer forms a cubic phase with 15 wt. % glycerol at 55° C. FIG. 13 shows PLM images of the Gemini 6-18-EZ monomer in 15% glycerol at 20° C., where the crystals are visible, and at 55° C., which appears back due to its cubic structure. After UV curing the film, XRD analysis shown in FIG. 14 shows a very strong diffraction peak below 3°. Both PLM and XRD confirmed the bi-continuous cubic phase structure has been formed.

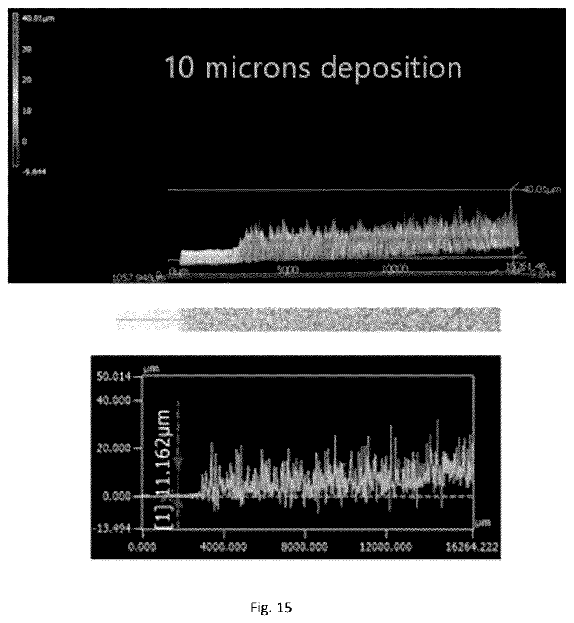

A spray-application step was done to coat the cathode at 0.3, 0.5, 1, 5, and 10 micron-thick with very high accuracy and reproducibility. The applicator was an ExactaCoat OP3 Ultrasonic Sprayer. The ultrasonic nozzle of the system applies a uniform liquid layer on the electrode in a precise, repeatable, controllable, and low-volume atomized spray pattern. A laser profilometer/microscope calibrated the film thickness versus sprayed volume. An example of the profilometer scans for the 10-micron is shown in FIG. 15.

To apply the polymer film on the composite and cast the materials into a cathode, the C/S composite may be mixed with Gemini in methanol. After sufficient sonication, 30 minutes, to thoroughly wet the composite, the methanol is evaporated using a rotary evaporator. While in rotation, the dry powder is heated and UV cured using a heat/UV lamp at 650 for an hour. The coating thickness will increase or decrease based on the Gemini concentration in the mixing solution. After that, 95 wt % coated C/S composite is mixed with 5 wt % LA133 (an aqueous binder) in water. The slurry is mixed and milled with small zirconium media (5 mm beads) to break up agglomeration. The slurry is cast with a 10 mil gap doctor blade, dried at 55° C. for 1 hour, and calendared at 1.5 ton for 30 seconds to produce a C/S cathode.

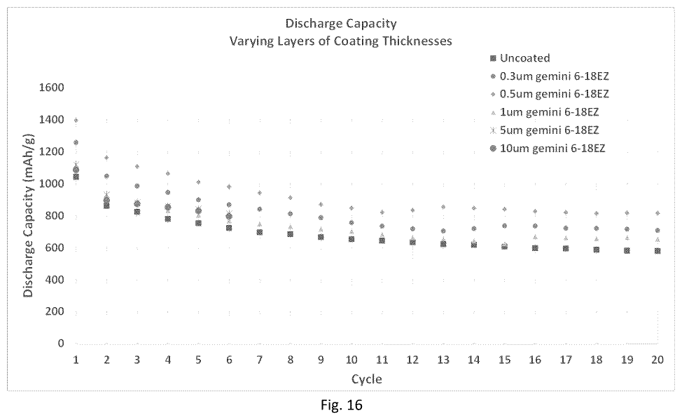

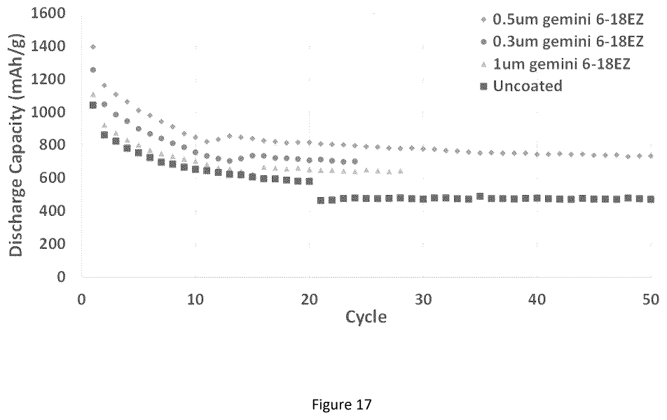

The samples were tested in coin cells. FIG. 16 shows the discharged capacities tested in coin cells for different coating thicknesses of Gemini 6-18EZ-C2. The initial discharged capacity was highest at 0.5 microns at ˜1400 mAh/g. At 0.3 microns, the initial discharged capacity was ˜1250 mAh/g. At 1 micron or thicker, the initial discharged capacity was lower (˜1100 mAh/g), which could be from the higher interfacial resistance of the polymer film. After 50 cycles, the capacity was stable at ˜800 mAh/g for the 0.5 micron coated cathode, as shown in FIG. 17. Based on the data, the preferred thickness for coating the C/S cathode is 0.3-1 micron, more preferably 0.4-0.6 microns, or most preferably 0.5 microns.

To scale-up the process, a PARR reactor may be used. With stirring, the mixture of carbon and sulfur is heated to 500° C. for 18 hours under inert atmosphere for 18 hours. This process can make >1.5 kg of C/S composite. The carbon has a high surface area (>1400 m²/g) and a high pore volume (>1.5 mL/g).

Assuming that the carbon contains 50 wt % (or more) of sulfur, the cathode capacity is at least 837.5 mAh/g. Because the nominal voltage of Li—S is 2.15 V, we need 6 cells (in series) to gain 12.9 V.

The best composite for scaling up and making high-density lithium sulfur batteries are disclosed herein, but routine experimentation may identify modifications to the claimed ranges. The composite described herein contains the highest sulfur loading, strongest sulfur-carbon bonding, highest capacity, and energy density when formulated with 7.5 wt % LA133 binder and 2.5 wt % of conducting polymer. This composite is easy to scale up and can be done in a single step. The binder is water-based, easy to formulate, and quick drying. Table 3 summarizes the optimal parameters, conditions, and materials for the composite.

TABLE 3
Optimal parameters, conditions, and materials.

| | |
|---|---|
| Sulfur/Carbon impregnation process | 500° C./18 h/inert |
| Total sulfur Loading | 70 wt % composite |
| Amount of sulfur in the pores | 50% pore volume |
| Cathode loading | 7-8 mg/cm² |
| Binder | LA133 |
| Ink formulation | 90 wt % composite, 7.5 wt % |
| | LA133, 2.5 wt % PEDOT |
| Protective nanoporous polymer | Gemini C2-6, 18-EZ |

In an example, the anode is an ultra-thin lithium (6.5 microns) copper (10 microns) double sides laminated foil. The separator is a Whatman glass filter (GF/C GFA) with 70% open pores space. The electrolyte is 1 M LiTFSI in DOL:DME (1:1 wt.) with a 1.0 g/mL density. Assuming 10 mg of C/S composite loaded per cm², the cell pack dimension is 2.8×1.6×2.0 inches (L×W×H) constructed of 6 16-Ah pouch cells. Each pouch cell has 33 double-sided and 2 single-sided layers, weighing ˜0.13 lb (including pouch foil, main tabs, cathode, anode, electrolyte, and separator). The cell pack can deliver 206 Wh or 576 Wh/kg, which qualifies for the handheld radio batteries used in military radio systems. Table 4 summarizes the differences between current lithium-ion batteries, and the Li—S batteries described herein.

TABLE 4
Current versus presented battery specifications

| | Capacity | Energy | Energy Density |
|---|---|---|---|
| Type | (Ah) | (Wh) | (Wh/kg) |
| BT-70716BE | 5.8 | 63 | 175 |
| BT-70716BG | 6.8 | 73 | 202 |
| BT-70716BV | 7 | 87 | 256 |
| ELI-152 | 7 | 76 | 216 |
| C/S composite with | 16 | 206 | 576 |
| Li-conducting layer | | | |

The disclosed battery surpasses current available lithium ion batteries, of which the best only achieves an energy density of around 250 Wh/kg. A lithium-sulfur battery comprising the disclosed carbon/sulfur composite, with porous carbon supports and a protective lithium-active polymer membrane, achieves energy densities above 300 Wh/kg, above 400 Wh/kg, and in a most preferred embodiment above 500 Wh/kg. The lithium-sulfur battery described herein may provide an energy density of above 500 Wh/kg. This quality allows for much longer-term battery use between recharging, making military handheld radio use possible in remote areas, as well as other equipment that may utilize the battery.

What is claimed is:

1. A lithium-sulfur battery, comprising:
a lithium metal anode;
a sulfur cathode, comprising a carbon/sulfur composite;
an electrolyte; and,
a separator;
wherein, the carbon/sulfur composite comprises:
a carbon core;
an activated carbon support surrounding the carbon core comprising a plurality of pores;
a sulfur species within the plurality of pores; and,
a polymer membrane encapsulating the activated carbon support and the sulfur species.

2. A lithium-sulfur battery as in claim 1, wherein the sulfur cathode further comprises a binder.

3. A lithium-sulfur battery as in claim 2, wherein the binder is CMC/SBR or LA133.

4. A lithium-sulfur battery as in claim 1, wherein the plurality of pores has a pore volume of 0.64-1.54 mL/g.

5. A lithium-sulfur battery as in claim 4, wherein the plurality of pores has a pore volume of 0.86 m L/g-1.54 m L/g.

6. A lithium-sulfur battery as in claim 1, wherein each pore in the plurality of pores has a diameter of 2-70 nm.

7. A lithium-sulfur battery as in claim 1, wherein the sulfur species comprises at least 50 wt % of the carbon/sulfur composite.

8. A lithium-sulfur battery as in claim 1, wherein the carbon core comprises at least one nitrogen-containing compound.

9. A lithium-sulfur battery as in claim 8, wherein the at least one nitrogen-containing compound is selected from the group consisting of: urea, glycine, and melamine.

10. A lithium-sulfur battery as in claim 1, wherein the polymer membrane is lithium-conducting.

11. A lithium-sulfur battery as in claim 10, wherein the polymer membrane comprises a surfactant that forms an isotropic cubic phase.

12. A lithium-sulfur battery as in claim 11, wherein the surfactant forms a bi-continuous cubic phase.

13. A lithium-sulfur battery as in claim 11, wherein the surfactant is a lyotrophic liquid crystalline (LLC) monomer.

14. A lithium-sulfur battery as in claim 11, wherein the surfactant is a 3-tailed surfactant.

15. A lithium-sulfur battery as in claim 11, wherein the polymer membrane has a thickness of 0.3-10 microns.

16. A lithium-sulfur battery as in claim 15, wherein the polymer membrane has a thickness of 0.4-0.6 microns.

17. A lithium-sulfur battery as in claim 16, wherein the polymer membrane has a thickness of 0.5 microns.

18. A lithium-sulfur battery as in claim 11, wherein the polymer membrane prevents polysulfide migration and stabilizes the lithium-sulfur battery.

19. A lithium-sulfur battery as in claim 1, wherein the lithium-sulfur battery has an energy density more than 300 Wh/kg.

20. A lithium-sulfur battery as in claim 19, wherein the lithium-sulfur battery has an energy density more than 500 Wh/kg.
